(19) United States
(12) Patent Application Publication
(10) Pub. No.: US 2003/0123687 A1
(43) Pub. Date: Jul. 3, 2003

(54) Modular hearing aid assembly

(75) Inventors: Hardy L. Petrick, Niles, IL (US); Paul R. Stonikas, Darien, IL (US); Gregory Prutnikov, Niles, IL (US); Manolo J. Blancaflor, Desplaines, IL (US)

Correspondence Address: David G. Beck, Bingham McCutchen, LLP, Three Embarcadero Center, San Francisco, CA, 94111, US

(73) Assignee: GN ReSound A/S

(21) Appl. No.: 10/301,199

(22) Filed: Nov. 21, 2002

Related U.S. Application Data
(60) Provisional application No. 60/333,580, filed on Nov. 27, 2001.

(51) Int. Cl. H04R 25/00

(52) U.S. Cl. 381/322; 381/312; 381/314; 381/323; 381/324

(57) ABSTRACT

A method of fabricating a modular hearing aid as well as the resultant hearing aid is provided. The provided hearing aid is comprised of a shell and a faceplate assembly. The shell may be formed of a soft, flexible material or a rigid or semi-rigid material. The faceplate assembly is comprised of at least a pair of pieces, preferably an upper faceplate piece and a lower faceplate piece, and can be fabricated from a variety of different materials. During assembly, a portion of the shell is captured within the faceplate assembly, for example between the upper and lower faceplate pieces. The individual faceplate pieces can be attached to one another using any of a variety of techniques, including miniature screws, interlocking and complementary members, fastening clips or other means. The faceplate assembly can also be coupled together using a permanent or semi-permanent means, although the use of a permanent means limits the ease with which the device can be disassembled.

### CROSS-REFERENCES TO RELATED APPLICATIONS

This application claims the benefit of U.S. Provisional Patent Application Serial No. 60/333,580, filed Nov. 27, 2001, the specification of which is incorporated herein in its entirety for any and all purposes.

### BACKGROUND OF THE INVENTION

Hearing aids utilize a variety of designs, reflecting not only the hearing deficiencies for which they are designed, but just as importantly the fashion, comfort and cost requirements of the user. For example, although a behind-the-ear (BTE) hearing aid may be inexpensive to manufacture and thus relatively inexpensive to purchase, some users may be unwilling to use this style hearing aid because they find it uncomfortable for extended use or because they find the design too conspicuous. In an attempt to provide a less conspicuous form of hearing aid, many manufacturers have developed in-the-ear (ITE) designs that either partly or completely reside within the user's ear canal. Due to their size and position during use, however, ITE hearing aids present unique miniaturization, fabrication and fit problems.

Conventional ITE hearing aids are comprised of a rigid mounting plate, commonly called a faceplate, and a contoured shell designed to fit within the user's ear canal. Typically the electronics associated with the hearing aid, including the input transducer or microphone, signal processor, output transducer or speaker and battery compartment, are attached to the faceplate. The faceplate may also include a programming port, volume control, on/off switch and/or other desirable feature. During fabrication of a conventional ITE hearing aid, normally the electronics are first attached to an over-sized faceplate and then the shell is bonded to the faceplate. After the adhesive has cured, excess faceplate material is trimmed and sanded away.

There are several drawbacks associated with conventional ITE hearing aids. First, the fabrication process is very labor intensive, thus leading to high manufacturing costs. Second, the shells are often individually sized and shaped, further impacting manufacturing costs. Third, due to the limited flexure offered by a typical shell, the user may experience discomfort, especially after extending wear. Fourth, as the shell is bonded to the faceplate, maintenance of the hearing aid after fabrication requires that the hearing aid be cracked or machined open, adding to the time and expense associated with repairs. Fifth, as the user talks or otherwise flexes their jaw muscles, changes in the shape of the user's ear canal results in variations in the seal between the ear canal and the outer surface of the conventional shell, leading to sound leaks which are a source of signal feedback.

Compliant or “soft” ITE hearing aids may overcome many, if not all, of the deficiencies associated with conventional ITE hearing aids. These hearing aids are often similar to conventional ITE hearing aids in design except that the shell is comprised of a flexible material, thus providing a much more comfortable fit within the user's ear canal. Unfortunately, the use of a shell comprised of a material different from that used to manufacture the faceplate, and in particular a shell comprised of a silicone or other soft material, presents unique fabrication problems. In particular, attaching the soft shell to the faceplate is difficult using the conventional approach as most adhesives, especially quick setting or “instant” adhesives, do not bond well to many soft shell materials (e.g., silicones). In some cases the adhesive may form an initially sound bond, but then the bond strength will weaken after exposure to moisture. If a slower setting adhesive is used in order to achieve better bond strength, more complex holding fixtures are required to hold the components in place during the curing cycle. Thus slower setting adhesives add to fabrication complexity and cost while slowing down the fabrication process. In addition, once the shell is bonded to the faceplate, it is extremely difficult to detach the shell from the faceplate, for example to allow routine maintenance, without tearing the shell material or otherwise damaging the device.

Accordingly, what is needed in the art is an ITE hearing aid that is simple to fabricate and that allows detachment of the shell from the faceplate without damaging one or both components. The present invention provides such an ITE hearing aid.

### SUMMARY OF THE INVENTION

The present invention provides a method of fabricating a modular hearing aid as well as the resultant hearing aid. The hearing aid of the invention is comprised of a shell and a faceplate assembly. The shell may be formed of a soft, flexible material or a rigid or semi-rigid material. The faceplate assembly is comprised of at least a pair of pieces, preferably an upper faceplate piece and a lower faceplate piece. During assembly, a portion of the shell is captured within the faceplate assembly, for example between the upper and lower faceplate pieces. The upper and lower pieces of the faceplate can be attached to one another using any of a variety of techniques, including miniature screws, interlocking and complementary members, fastening clips or other means. Preferably the upper and lower faceplate pieces are releasably coupled to one another, thus allowing easy disassembly of the device for maintenance or internal calibration. The upper and lower pieces can also be attached to one another using a permanent or semi-permanent means, although using permanent means limits the ease with which the device can be disassembled.

A further understanding of the nature and advantages of the present invention may be realized by reference to the remaining portions of the specification and the drawings.

### BRIEF DESCRIPTION OF THE DRAWINGS

FIG. 1 is an illustration of a conventional ITE hearing aid;

FIG. 2 is a top view of a faceplate;

FIG. 3 illustrates where the shell is to be attached to the faceplate shown in FIG. 2;

FIG. 4 is a cross-sectional view of the ITE hearing aid of FIG. 1 prior to removal of excess faceplate material;

FIG. 5 is a cross-sectional view of an ITE hearing aid fabricated in accordance with the invention;

FIG. 6 is a perspective view of an ITE hearing aid similar to that shown in FIG. 5;

FIG. 7 illustrates a method of capturing a “T” portion of a shell between an upper faceplate piece and a lower faceplate piece;

FIG. 8 illustrates an alternative to the capture technique shown in FIG. 7, in which only a single lip is captured between the faceplate pieces;

FIG. 9 illustrates another alternative to the capture technique shown in FIG. 7, in which the shell is merely clamped between the upper and lower faceplate pieces and in which no lip is used to insure shell retention;

FIG. 10 illustrates another alternate shell capture technique in which a spherically-shaped portion of the shell is completely captured by the faceplate assembly;

FIG. 11 illustrates another alternate shell capture technique in which the gripping surfaces of the upper and lower faceplate pieces have been treated;

FIG. 12 illustrates another alternate shell capture technique in which the surfaces of the shell that are gripped by the upper and lower faceplate pieces have been treated;

FIG. 13 illustrates a method of capturing a portion of a shell between the inner and outer side surfaces of the upper and lower faceplate pieces, respectively;

FIG. 14 illustrates an alternate method of capturing a portion of a shell between the inner and outer side surfaces of the upper and lower faceplate pieces, respectively;

FIG. 15 illustrates an alternate method of capturing a portion of a shell between first and second faceplate pieces, the method utilizing an additional sealing member;

FIG. 16 illustrates an alternate method of capturing a shell by a faceplate assembly, the method utilizing an intermediary member interposed between the faceplate assembly and the shell;

FIG. 17 illustrates a pair of interlocking members that can be used with the present invention to hold together the upper and lower faceplate pieces;

FIG. 18 illustrates a single locking member and a complementary locking portion that can be used with the present invention to hold together the upper and lower faceplate pieces; and

FIG. 19 illustrates an embodiment in which the locking members use complementary grooves and ridges to hold together the upper and lower faceplate pieces.

### DESCRIPTION OF THE SPECIFIC EMBODIMENTS

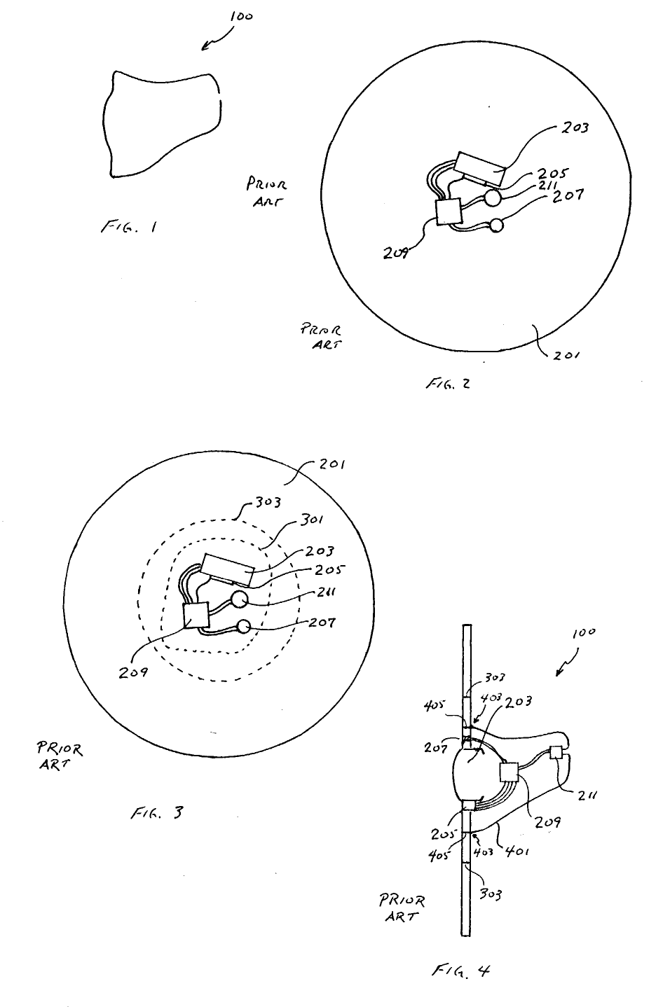

FIGS. 2-4 illustrate a few of the basic steps required to fabricate the conventional ITE hearing aid 100 illustrated in FIG. 1. FIG. 2 is a top view of a faceplate 201 to which several components are shown attached, including a battery compartment 203, a microphone 205 and a volume control 207. Several additional components are shown that are not attached to faceplate 201, but further comprise the electronics associated with the hearing aid, including amplifier 209 and speaker 211.

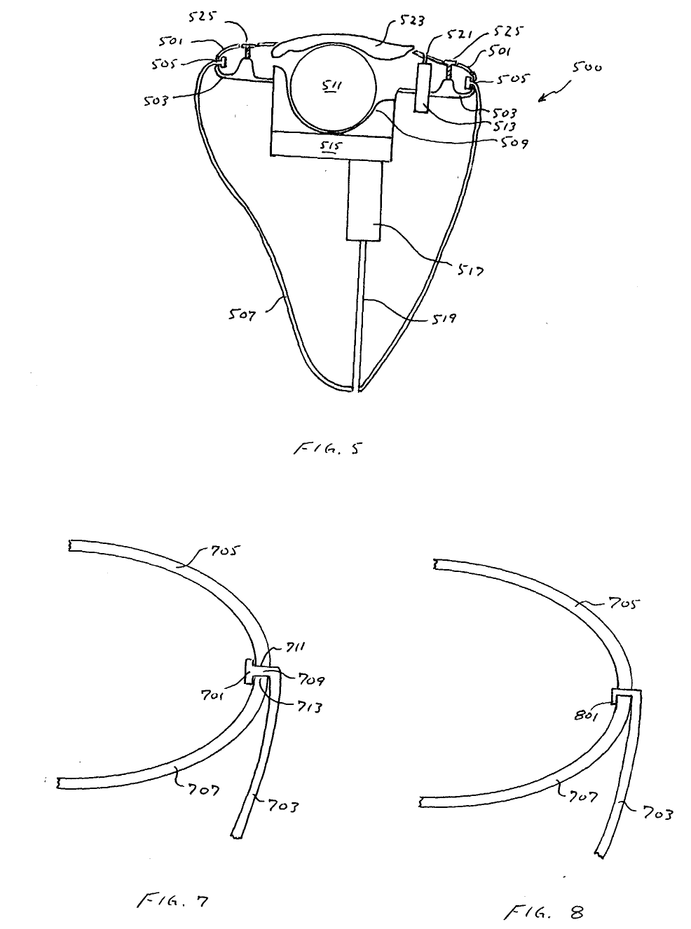

FIG. 3 is a second view of faceplate 201 showing, via shadow line 301, the intended point of attachment of the shell. As further illustrated in the cross-sectional view provided in FIG. 4, shell 401 attaches to faceplate 201 at a juncture 403. Typically the attachment of shell 401 to faceplate 201 is accomplished with a quick-set bonding agent. After the bonding agent has sufficiently cured, a portion of faceplate 201 is trimmed away by cutting along a line 303. The remaining portion of faceplate 201 that extends past shell 401 is then removed, typically by a process of hand buffing and polishing the edge of faceplate 201 until its edge is smooth and in-line with the edge of shell 401 (i.e., faceplate edge 405).

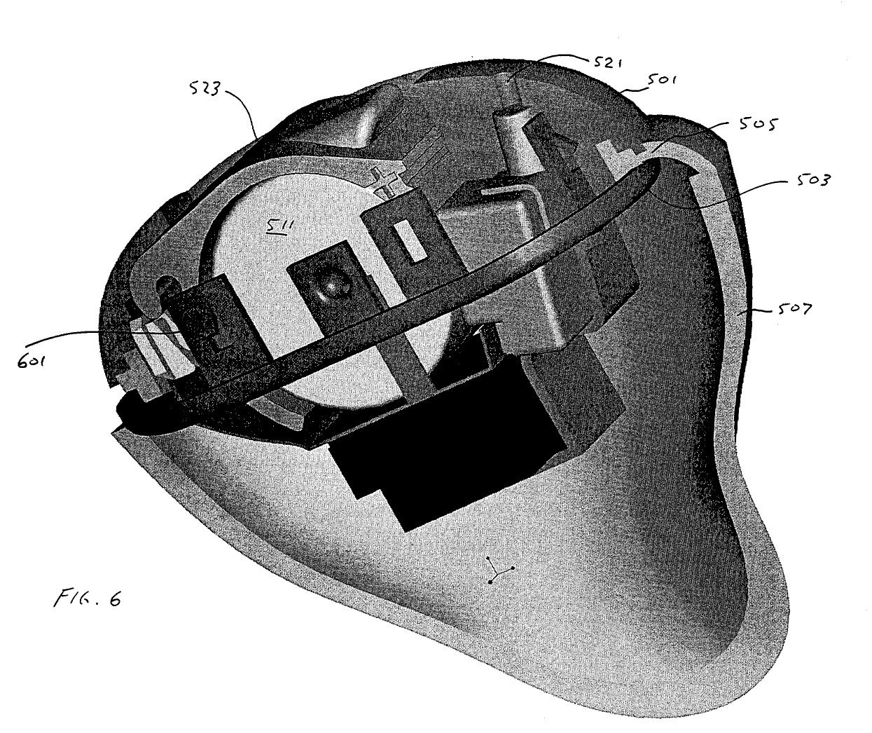

According to the present invention and as illustrated in the cross-sectional view shown in FIG. 5 and the perspective cross-sectional view shown in FIG. 6, the hearing aid faceplate assembly is comprised of at least two pieces such as a first (e.g., upper) faceplate piece 501 and a second (e.g., lower) faceplate piece 503 which, when joined together, capture an edge or end portion 505 of a shell 507. In the preferred embodiments, shell 507 is a compliant or soft shell fabricated from any suitable, flexible material such as an elastomer, silicone, latex, polyurethane, polyvinyl, or polymer. If shell 507 is comprised of a compliant or soft material, it can be fabricated in a variety of ways known to those of skill in the manufacturing arts, for example, as disclosed in U.S. Pat. No. 6,393,130 or U.S. patent application Ser. Nos. US2001/0008560 or US2002/0025055, the disclosures of which are incorporated herein in their entirety for any and all purposes, or by any other means known by those of skill in the art. The individual pieces that comprise the faceplate assembly are preferably fabricated from a rigid or semi-rigid material, for example a metal, plastic or ceramic. It is understood that the individual pieces that comprise the faceplate assembly can be fabricated from different materials, for example, the lower faceplate piece can be fabricated from a metal while the upper faceplate piece can be fabricated from a plastic.

Attached to the faceplate assembly are the various elements that may comprise hearing aid 500, preferably in a design layout that is acoustically stable when the hearing aid is assembled. Shown in FIGS. 5 and 6 are a battery compartment 509 (with a battery 511 shown), a microphone 513, and a processor/amplifier 515. FIG. 5 also shows a speaker 517 coupled to the end portion of shell 507 via a sound tube 519. FIGS. 5 and 6 also show a microphone port 521 and a battery compartment door 523 attached to upper faceplate portion 501. It will be appreciated that the components shown in FIG. 5 and, in part, in FIG. 6, are for illustration purposes only and that the present invention is not limited to hearing aids or other devices that include the same set of components. For example, the system could also include a push-button on/off switch (not shown), a volume control (not shown), programming switch (not shown), telecoil (not shown) and/or a vent tube (not shown). It will also be appreciated that the configuration illustrated in these figures is meant for illustrative purposes only and that the invention is equally applicable to other configurations. For example, all of the electronic components comprising the hearing device can be attached to the upper faceplate piece and, during assembly, can pass through an open portion of the lower faceplate piece.

In a preferred embodiment of the invention, faceplate assemblies are fabricated in advance of need, with the locations of the various components being independent of the shell that is to be eventually mated to a particular faceplate assembly. If desired, faceplate assemblies can be pre-fabricated with various component combinations (e.g., with/without on/off switch, with/without volume control, etc.), thus allowing an inventory of likely configurations to be accumulated. Furthermore, the faceplate assemblies can be pre-fabricated in more than one size, thus providing the installer more flexibility in fitting a particular sized shell to the faceplate assembly. Lastly, due to the modular design, a few lower faceplate assemblies along with a variety of cosmetically different upper faceplates and shells can be used to fabricate any of a large variety of individualized hearing aids from a relatively small inventory.

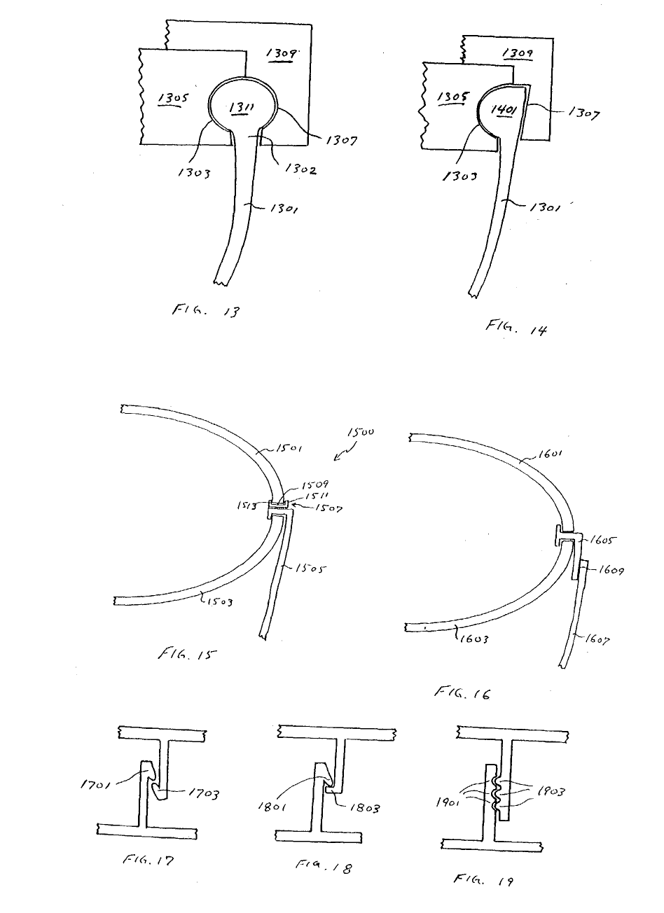

FIGS. 7-16 illustrate a variety of techniques that may be used to capture a shell with a faceplate assembly. Preferably and as illustrated in FIGS. 7-14, a portion of the shell is captured between a pair of faceplate pieces, i.e., first and second faceplate pieces, the pair of faceplate pieces comprising the faceplate assembly. It will be appreciated, however, that the faceplate assembly can be comprised of more than a pair of pieces (e.g., the configuration shown in FIG. 15) or that the faceplate assembly can attach to an intermediary member that then, in turn, attaches to the shell (e.g., the configuration shown in FIG. 16).

FIG. 7 provides a close-up of the capture technique shown in FIGS. 5 and 6. As illustrated, a “T” retention member 701 of shell 703 is captured within the faceplate assembly cavity that is formed by the assembly of faceplate pieces 705 and 707, retention member 701 holding shell 703 in place. It will be appreciated that although a retention member can be used as the sole capture mechanism, shell retention can be augmented by gripping or compressing edge portion 709 between complementary faceplate surfaces 711 and 713, the amount of holding force being proportional to the force applied by complementary surfaces 711 and 713 and thus dependent upon the means used to couple the faceplate assembly. To insure a secure shell mount, preferably both edge compression and a retention member are used.

It will be appreciated that although the retention member shown in FIG. 7 employs a “T” shape, the invention could also utilize other shapes (e.g., spherical, irregular, etc.). For example, shell 703 could utilize a single lip 801 (“L” shaped) as shown in FIG. 8. As previously noted, preferably the shell is held not only by capturing retention member 801 within the faceplate assembly, but also by clamping or compressing an edge portion of the shell between the two faceplate pieces.

In another preferred embodiment, shell 703 does not include a retention member and relies solely on the clamping feature of the faceplate assembly to hold the shell in place. Thus as illustrated in FIG. 9, shell edge portion 709 is held by compressing the edge portion between complementary faceplate surfaces 711 and 713.

FIG. 10 illustrates an alternate shell capture technique in which a shaped portion 1001 of shell 1003 is completely captured between adjacent and complementary surfaces 1005 and 1007 of first faceplate piece 1009 and second faceplate piece 1011, respectively. Although in the illustrated embodiment portion 1001 is spherically shaped, it will be appreciated that other shapes could also be used (e.g., T-shaped, L-shaped, irregularly shaped, etc.). In this embodiment, the capture mechanism can solely rely on the shaped portion 1001 being held in a similarly shaped cavity formed by the combination of surfaces 1005 and 1007. Alternately, the capture mechanism can rely both on the shaped portion 1001 fitting within the complementary cavity formed by the faceplate assembly and on the compressive forces applied by surfaces 1005 and 1007 to shaped portion 1001 and to any other shell material that is captured by the complementary faceplate surfaces.

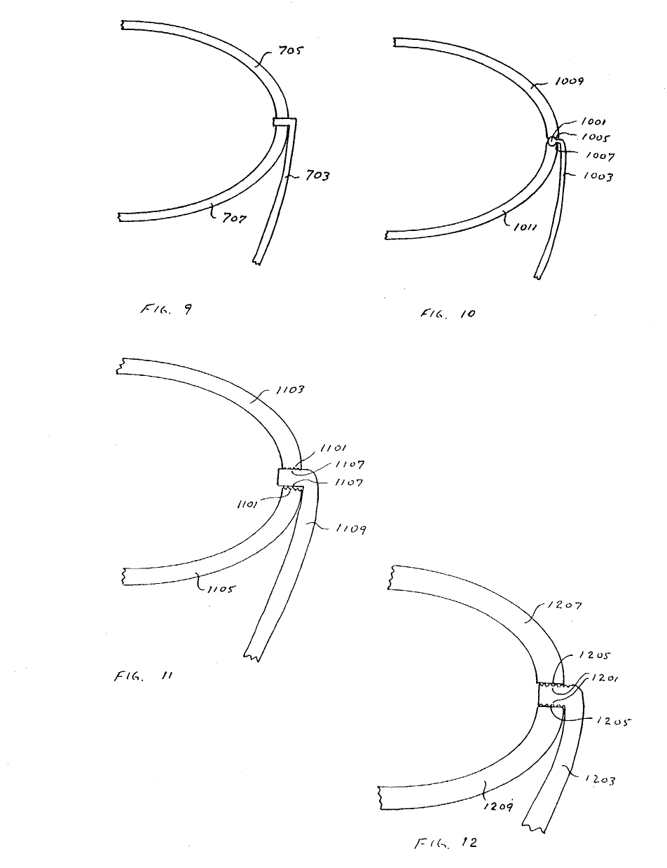

FIGS. 11 and 12 illustrate yet another alternate shell capture technique. In this embodiment, one or more of the complementary surfaces of the faceplate pieces and the shell are textured, treated or formed to enhance the ability of the faceplate assembly to seize and retain the shell. Surface treatment can either take place after the component is fabricated (e.g., coating a fabricated surface, roughening a surface, etc.) or during fabrication (e.g., molding a roughened surface on the complementary surfaces of the faceplate pieces, etc.). For example as shown in FIG. 11, surfaces 1101 of upper faceplate 1103 and lower faceplate 1 05 are serrated, thus allowing them to better grip surfaces 1107 of shell portion 1109. Alternately as shown in FIG. 12, surfaces 1201 of shell portion 1203 have been treated (e.g., serrated) while surfaces 1205 of upper faceplate 1207 and lower faceplate 1209 are untreated. It will be appreciated that the mating surfaces of the shell and the faceplate pieces can both be treated. It will also be appreciated that the surface treatment can include serrations or other forms of surface roughening or texturing, surface coatings (e.g., application of an elastomeric material on the gripping surfaces), adhesives or any other type of surface treatment that improves the retention characteristics of the faceplate assembly. It will also be appreciated that the surface treatments disclosed above could be used with any of the disclosed shell capture techniques (e.g., those illustrated in FIGS. 7-10 and FIGS. 13-14), thereby enhancing the ability of the faceplate surfaces to grip the shell.

As previously disclosed, the present invention is not limited to faceplate assemblies comprised only of pairs of faceplates, nor is the invention limited to capture techniques utilizing horizontal faceplate surfaces. For example, FIGS. 13-14 illustrate embodiments in which a portion of the shell is captured between an exterior side surface of one faceplate and an interior side surface of a second faceplate. In FIG. 13, a portion 1302 of shell 1301 is located, after assembly, between side 1303 of first faceplate 1305 and side 1307 of second faceplate 1309. Preferably a portion of shell 1301, for example end portion 1311, is shaped to enhance the ability of the separate pieces of the faceplate to capture and retain the shell. It will be appreciated that any of a variety of shapes can be utilized (e.g., portion 1401 of FIG. 14) and that one or more of the surfaces can be treated as disclosed above to enhance the ability of the surfaces to grip the shell.

In yet another embodiment of the invention, the faceplate assembly is comprised of more than two faceplate pieces. Additional faceplate pieces can be used to improve shell retention and/or shell to faceplate sealing, reduce fabrication and assembly complexity, or to simply provide cosmetic improvements (e.g., different colored exterior faceplate caps). FIG. 15 illustrates one such faceplate assembly 1500. As in previously illustrated faceplate assemblies, assembly 1500 includes a first faceplate piece 1501 and a second faceplate piece 1503 which are used to capture a portion of a shell 1505. This assembly also includes a third faceplate member 1507 that is interposed between one surface of shell 1505 and first faceplate piece 1501. It will be appreciated that member 1507 could also be interposed between shell 1505 and the second faceplate piece 1503 or that a pair of members 1507 could be used, one interposed between a first side of shell 1505 and faceplate piece 1501 and the second interposed between a second side of shell 1505 and faceplate piece 1503. Preferably member 1505 is comprised of a material that is suitable for sealing the shell to the faceplate assembly (e.g., elastomers, silicones, latex, polyurethanes, or polyvinyls). In a preferred embodiment, shell 1501 is a rigid or semirigid shell and member 1505 is formed to fit tightly onto the edge of faceplate piece 1501 (or alternately, faceplate piece 1503), typically through the inclusion of mounting surfaces 1509 and 1511 in addition to sealing surface 1513.

In yet another embodiment of the invention, the faceplate assembly captures an intermediary member which then, in turn, is coupled to the shell. For example, as shown in FIG. 16, a pair of faceplate pieces 1601 and 1603 capture an intermediary member 1605. Any of the previously disclosed capture techniques can be used, including the use of shaped retention members, compression techniques, etc. Attached to intermediary member 1605, preferably after it has been coupled to the faceplate assembly, is shell 1607. In a preferred embodiment, shell 1607 is comprised of a flexible material (e.g., elastomers, silicones, latex, polyurethanes, polyvinyls or polymers) and is preferably bonded to member 1605 along a bond line 1609.

Another aspect of the invention is the means by which the first and second faceplate pieces (e.g., upper and lower pieces) are coupled together, thereby capturing the shell or intermediary member. For example, in the cross-sectional illustration of FIG. 5, the upper and lower faceplate pieces are held together with one or more screws 525. In the perspective cross-sectional illustration of FIG. 6, the upper and lower faceplate pieces are held together with one or more complementary, interlocking members 601. If such interlocking members are used, preferably during assembly the upper and lower faceplate pieces are aligned and pressed together, causing the complementary members to lock together, thereby capturing the shell as previously disclosed. FIGS. 17-19 show three pairs, respectively, of interlocking members. Specifically, FIG. 17 illustrates an embodiment using interlocking barbs 1701 and 1703; FIG. 18 illustrates an embodiment using a barb 1801 on one of the faceplate pieces with a lockable portion 1803 on the opposing faceplate piece; and FIG. 19 illustrates an embodiment using complementary grooves 1901 and ridges 1903. It will be appreciated that these figures are only meant to illustrate a few types of interlocking members that can be used with the present invention. Other types of latches known by those familiar in the art can also be used in the present invention. Additionally, it will be appreciated that the upper and lower faceplate members can also be joined together using adhesives, welding techniques (e.g., ultra-sonic welding), heat sealing, staking techniques (e.g., heat staking) or rivets.

Although many of the above-described embodiments recite a soft or compliant shell, as previously noted the invention can also be used to fabricate hearing devices in which the shell is rigid or semi-rigid. In this instance, one of the advantages of the modular approach of the present invention over conventional assembly techniques is the ability to easily disassemble a device for repair, adjustment or component updating.

As will be understood by those familiar with the art, the present invention may be embodied in other specific forms without departing from the spirit or essential characteristics thereof. For example, the assembly techniques disclosed herein could be used for either a wired or wireless earpiece for use with a telephone or other audio device. Accordingly, the disclosures and descriptions herein are intended to be illustrative, but not limiting, of the scope of the invention which is set forth in the following claims.

What is claimed is:

1. A modular hearing device comprising:
a shell;
a first faceplate piece;
a second faceplate piece; and
means for coupling said first and second faceplate pieces, wherein a portion of said shell is captured between said first and second faceplate pieces when said first and second faceplate pieces are coupled together.

2. A modular hearing device comprising:
a first faceplate;
a second faceplate coupleable to said first faceplate;
a shell having an open end with a shell edge portion; and
means for coupling said first and second faceplates, wherein said shell edge portion extends between a first faceplate surface and a second, complementary faceplate surface.

3. The modular hearing device of claim 2, wherein said shell edge portion further comprises a shaped portion.

4. The modular hearing device of claim 3, wherein said shaped portion is selected from the group consisting of T-shapes, L-shapes, spherical shapes and irregular shapes.

5. The modular hearing device of claim 3, wherein a faceplate assembly cavity is formed by said first faceplate coupled to said second faceplate and wherein at least a portion of said shaped portion resides within said faceplate assembly cavity.

6. The modular hearing device of claim 2, wherein said shell edge portion is compressed between said first faceplate surface and said second, complementary faceplate surface.

7. The modular hearing device of claim 3, wherein said shaped portion is captured between said first faceplate surface and said second, complementary faceplate surface.

8. The modular hearing device of claim 6, wherein at least one of said first faceplate surface, said second, complementary faceplate surface and said shell edge portion is treated to enhance shell edge retention.

9. The modular hearing device of claim 6, wherein at least one of said first faceplate surface, said second, complementary faceplate surface and said shell edge portion is roughened to enhance shell edge retention.

10. The modular hearing device of claim 6, wherein at least one of said first faceplate surface, said second, complementary faceplate surface and said shell edge portion is coated to enhance shell edge retention.

11. The modular hearing device of claim 7, wherein at least one of said first faceplate surface, said second, complementary faceplate surface and said shaped portion is treated to enhance shell edge retention.

12. The modular hearing device of claim 7, wherein at least one of said first faceplate surface, said second, complementary faceplate surface and said shaped portion is roughened to enhance shell edge retention.

13. The modular hearing device of claim 7, wherein at least one of said first faceplate surface, said second, complementary faceplate surface and said shaped portion is coated to enhance shell edge retention.

14. The modular hearing device of claim 2, wherein said means for coupling further comprises at least one screw.

15. The modular hearing device of claim 2, wherein said coupling means is comprised of at least one pair of complementary, interlockable members, wherein a first interlockable member of said at least one pair of complementary, interlockable members is coupled to said first faceplate and a second interlockable member of said at least one pair of complementary, interlockable members is coupled to said second faceplate.

16. The modular hearing device of claim 2, wherein said coupling means further comprises an adhesive.

17. The modular hearing device of claim 2, wherein said coupling means utilizes welding.

18. The modular hearing device of claim 2, wherein said coupling means utilizes staking.

19. The modular hearing device of claim 2, wherein said coupling means further comprises at least one rivet.

20. The modular hearing device of claim 2, wherein said coupling means is releasable.

21. The modular hearing device of claim 2, wherein said shell is comprised of a flexible material.

22. The modular hearing device of claim 21, wherein said flexible material is selected from the group of materials consisting of elastomers, silicones, latex, polyurethanes, polyvinyls and polymers.

23. The modular hearing device of claim 2, wherein said shell is comprised of a rigid material.

24. The modular hearing device of claim 2, further comprising a third faceplate member coupleable to said first faceplate.

25. The modular hearing device of claim 2, further comprising a third faceplate member interposed between said first faceplate and said shell edge portion.

26. A modular hearing device comprising:
a first faceplate;
a second faceplate coupleable to said first faceplate;
an intermediary member having an edge portion;
means for coupling said first and second faceplates, wherein said edge portion is captured between said first and second faceplates; and
a shell attachable to said intermediary member.

27. A modular hearing device comprising:
a faceplate assembly comprising:
a first faceplate;
a second faceplate releasably coupleable to said first faceplate;
a plurality of fasteners coupling said first faceplate and said second faceplate;
a battery compartment;
an input transducer;
an amplifier coupled to said input transducer;
an output transducer coupled to said amplifier; and
a shell having an open end with a shell edge portion, said shell comprised of a flexible material, wherein at least some of said shell edge portion is captured between a first surface of said first faceplate and a complementary surface of said second faceplate.

28. A faceplate assembly for use with a hearing device, the faceplate assembly adapted to a shell, the faceplate assembly comprising:
a first faceplate;
a second faceplate coupleable to said first faceplate; and
means for coupling said first and second faceplates to form said faceplate assembly, wherein a portion of said shell is capturable by said faceplate assembly.

29. The faceplate assembly of claim 28, wherein said coupling means is comprised of at least one screw.

30. The faceplate assembly of claim 28, wherein said coupling means is comprised of at least one pair of complementary, interlockable members, wherein a first interlockable member of said at least one pair of complementary, interlockable members is coupled to said first faceplate and a second interlockable member of said at least one pair of complementary, interlockable members is coupled to said second faceplate.

31. The faceplate assembly of claim 28, wherein said coupling means further comprises an adhesive.

32. The faceplate assembly of claim 28, wherein said coupling means utilizes welding.

33. The faceplate assembly of claim 28, wherein said coupling means utilizes staking.

34. The faceplate assembly of claim 28, wherein said coupling means further comprises at least one rivet.

35. The faceplate assembly of claim 28, wherein said coupling means is releasable.
